(19) United States
(12) Patent Application Publication
(10) Pub. No.: US 2025/0214891 A1
(43) Pub. Date: Jul. 3, 2025

(54) METHOD FOR PRODUCING CEMENT CLINKER

(71) Applicant: TOKUYAMA CORPORATION, Yamaguchi (JP)

(72) Inventors: Kenichi TSUJIO, Yamaguchi (JP); Ryota KAKIMOTO, Yamaguchi (JP); Takuya SEKI, Yamaguchi (JP); Kojiro MIYAZAKI, Yamaguchi (JP)

(73) Assignee: TOKUYAMA CORPORATION, Yamaguchi (JP)

(21) Appl. No.: 18/848,832

(22) PCT Filed: Mar. 9, 2023
(86) PCT No.: PCT/JP2023/008980

§ 371 Date: Sep. 19, 2024

(30) Foreign Application Priority Data
Mar. 28, 2022 (JP) 2022-052166

(51) Int. Cl. C04B 7/44; C04B 7/52; C04B 28/14

(52) U.S. Cl. CPC C04B 7/4407; C04B 7/52; C04B 28/14

(57) ABSTRACT

It is a production method of cement clinker comprising a calcination step of calcinating cement clinker powder raw material injected in a calcination kiln, with a kiln burner using a thermal energy source comprising gas fuel, wherein the used amount of gas fuel in the thermal energy source to be used in the kiln burner is adjusted so that the temperature of the kiln burner is lower that its heat resistant temperature.

### TECHNICAL FIELD

The present invention relates to a method for producing a cement clinker.

### BACKGROUND ART

Steps when producing cement include mainly a raw material preparing step of drying and crushing a cement clinker raw material such as limestone, clay, etc., a calcination step of calcinating the prepared cement clinker powder raw material with a calcination apparatus such as a calcination kiln, to produce a cement clinker, and a finishing step of adding gypsum, etc. to the produced cement clinker to make a cement.

In the calcination kiln, generally, carbon containing-thermal energy source such as petroleum, coal, etc. is used as a thermal source and there was a problem that a large amount of CO₂ is generated at the time of combustion.

Thus, for minifying CO₂ generation, it is proposed to use gas fuel with low CO₂ generation as main thermal energy source.

For example, a method of using hydrogen, methane, ethane, propane as gas fuel (see Patent Literature 1), or a method of using ammonia (see Patent Literature 2) is proposed.

### CITATION LIST

### Patent Literature

Patent Literature 1: Japanese Patent Laid-Open Publication No. 2018-052746

Patent Literature 2: Japanese Patent Laid-Open Publication No. 2019-137579

### SUMMARY OF INVENTION

### Technical Problem

Compared to when using carbon-containing thermal energy source such as petroleum, coal, etc., by using gas fuel such as hydrogen and methane, etc., the generation amount of CO₂ is decreased.

However, since the burning speed of gas fuel is faster as compared to carbon-containing thermal energy source such as petroleum, coal, etc., the temperature near the tip part of the kiln burner is increased and the temperature of the kiln burner may go over its heat resisting temperature, or even it does not, the heat damage (damage) of the kiln burner is significant, and the lifetime of exchanging the kiln burner becomes short. Generally, the calcination kiln is often maintained on an one year cycle, but the cycle becomes shorter, and when the operation is stopped for only exchanging the kiln burner besides usual maintenance, the operation is stopped for at least a few days, and the production efficiency becomes very bad.

The object of the present invention is to provide a method for producing a cement clinker that enables reducing the generation amount of CO₂, without affecting usual operation.

### Solution to Problem

As stated above, the present inventors have found that by using gas fuel in a calcination kiln to reduce the generation amount of CO₂, the temperature near the tip part of the kiln burner increases as compared to in case of using carbon-containing thermal energy source such as petroleum, coal, etc. Therefore, they found out that to suppress heat damage to the kiln burner, it is effective to limit the used amount of gas fuel in the calcination kiln. The present invention has been thus completed.

Specifically, the present invention is as follows.

[1] A method for producing a cement clinker comprising a calcination step of calcinating a cement clinker powder raw material injected in a calcination kiln with a kiln burner by using a thermal energy source comprising gas fuel,
wherein the used amount of the gas fuel in the thermal energy source to be used in the kiln burner is adjusted so that a temperature of the kiln burner is lower than a heat resistant temperature of the kiln burner.

[2] The method for producing a cement clinker according to [1], wherein the temperature of the kiln burner is adjusted to be 40° C. or more below the heat resistant temperature of the kiln burner.

[3] The method for producing a cement clinker according to [1] or [2], wherein the gas fuel is hydrogen.

[4] A method for producing a cement, comprising a finishing step of mixing gypsum to the cement clinker produced by the method for producing a cement clinker according to any one of [1] to [3], and crushing the cement clinker mixed with the gypsum.

### Advantageous Effects of Invention

According to the method for producing cement clinker of the present invention, the generation amount of CO₂ can be reduced without affecting usual operation.

### BRIEF DESCRIPTION OF DRAWING

FIG. 1 is a figure showing one example of the steps of the method for producing a cement clinker of the present invention.

FIG. 2 is a figure showing one example of the step of the method for producing a cement of the present invention.

### DESCRIPTION OF EMBODIMENTS

The method for producing cement clinker of the present invention is characterized by comprising a calcination step of calcinating a cement clinker powder raw material injected in a calcination kiln, with a kiln burner using a thermal energy source comprising gas fuel, wherein the used amount of the gas fuel in the thermal energy source to be used in the kiln burner is adjusted so that a temperature of the kiln burner is lower than a heat resistant temperature of the kiln burner.

Since the method of producing cement clinker of the present invention utilizes gas fuel as a part of thermal energy source used in a calcination kiln, the generation amount of CO₂ can be reduced as compared to in case of using only carbon-containing thermal energy source such as petroleum, coal, etc. On the other hand, when using gas fuel in the calcination kiln, since the burning speed of gas fuel is faster as compared to carbon-containing thermal energy source such as petroleum, coal, etc. the temperature near the tip part of the kiln burner increases and the kiln burner may be heat damaged. However, in the present invention, since gas fuel is used by being limited, it can be operated by suppressing heat damage of the kiln burner.

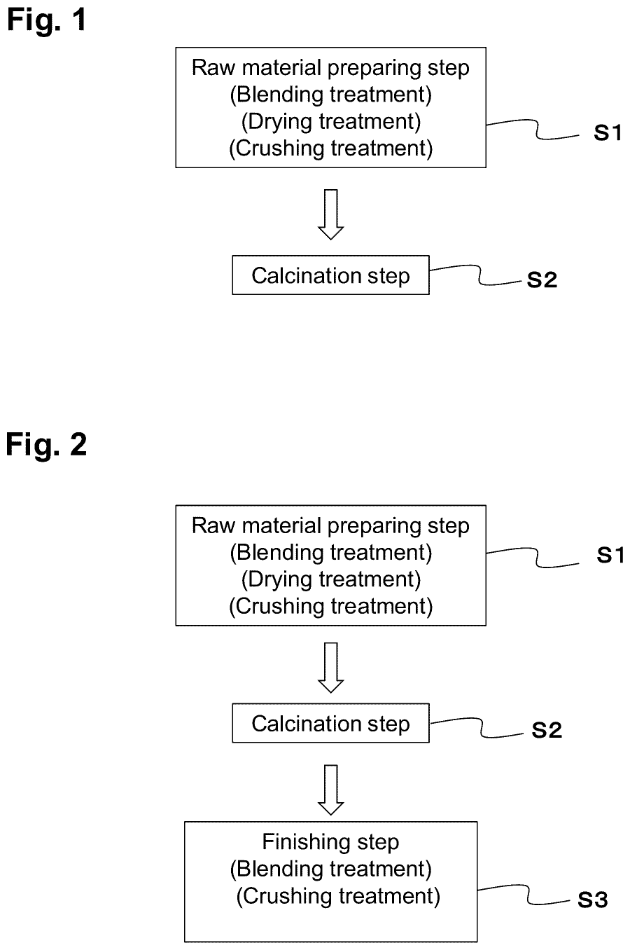

Here, FIG. 1 is a figure showing one example of the steps of the method for producing a cement clinker of the present invention. The production method of the present invention comprises generally a raw material preparing step before a calcination step. Each step is explained in detail in the following.

### Raw Material Preparing Step

Raw material preparing step is a step of drying and crushing cement clinker raw material to prepare powder raw material (step 1). Here, as cement clinker raw material, conventionally well-known common cement clinker raw materials such as limestone, clay, silica stone can be used.

In the raw material preparing step, mainly, blending treatment, drying treatment and crushing treatment are performed. Blending treatment is a treatment of blending each cement clinker raw material at a predetermined proportion according to the purpose. Drying treatment is a treatment of heat drying the cement clinker raw material by each raw material, or in a blended (mixed) state. Crushing treatment is a treatment of crushing dried cement clinker raw material, and can be performed at the same time as the drying treatment. Dyring treatment can be performed before the crushing treatment and/or at the same time as the crushing treatment.

In the drying treatment of the raw material preparing step, thermal energy of combustion gas generated in the calcination step can be used.

### Calcination Step

Calcination step is a step of calcinating the cement clinker powder raw material injected in the calcination kiln, with a kiln burner using thermal energy source comprising gas fuel (step 2).

As thermal energy source of the calcination step, generally carbon-containing thermal energy source such as petroleum, coal, etc. is used, while in the present invention, gas fuel is used as a part thereof. Examples of gas fuel include hydrogen, methane, ethane, propane, ammonia, etc., while in the point of calcination quality and that it does not at all generate CO₂, hydrogen is preferred. By using gas fuel as a part of thermal energy source, CO₂ generation by calcination can be reduced.

In the present step, the used amount of gas fuel in the thermal energy source to be used in the kiln burner is adjusted so that the temperature of the kiln burner is lower than the heat resistant temperature of the kiln burner. Specifically, by using gas fuel, the temperature of the flame near the kiln burner tip part becomes high, and the temperature of the kiln burner increases. Therefore, the used amount of gas fuel is limited to suppress the influence on the kiln burner.

Here, the heat resistant temperature of the kiln burner refers primary to the heat resistant temperature of the material, but in case there is a recommended temperature, etc. for continuous operation at high temperature, the recommended temperature has priority. When there is a range in the recommended temperature, the lower temperature being safer has priority. For example, SUS310S which is a heat resistant stainless steel, the heat resistant temperature as material is said to be 1035° C., while it is said that attention should be paid for a long-term heating at 700 to 900° C. Therefore, in such case, the heat resistant temperature is set as 700° C. and a temperature lower than this is used.

As stated above, in the present invention, it is sufficient to adjust the used amount of gas fuel in the thermal energy source to be used in a kiln burner so that the temperature of the kiln burner is lower than a heat resistant temperature of the kiln burner. However, to further reduce the load to the kiln burner, it is preferable to adjust to be 40° C. or more below the heat resistant temperature, further preferable to adjust to be 90° C. or more below; and furthermore preferable to adjust to be 110° C. or more below.

Further, by stating that the temperature of the kiln burner is lower than a prescribed temperature, it means that a temperature equal to or higher than the temperature is not maintained for 10 minutes or more, and it is preferable that it is noticed by an alarm or the like in case it attains a prescribed temperature or higher. In case there is a cautionary award such as alarm, etc. the status of the kiln burner is verified, and addressed appropriately.

Specifically, as the used amount of gas fuel, it is preferable to be 1 to 40% of the total thermal energy source on calorie basis, more preferable to be 5 to 35%, and further preferable to be 10 to 30%. The proportion of the gas fuel can be determined by considering both the reduction of CO₂ contained in the generated combustion gas and the influence on the kiln burner. As stated above, according to the method for producing a cement clinker of the present invention, it is possible to reduce the generation amount of CO₂ by suppressing the influence on the kiln burner, without affecting usual operation.

Further, the method for producing cement of the present invention is characterized by comprising a finishing step of mixing gypsum to the cement clinker produced by the above-mentioned production method, and crushing the cement clinker mixed with the gypsum. Here, FIG. 2 is a figure showing one example of the steps of the method for producing cement of the present invention.

### Finishing Step

In the finishing step, at least gypsum is mixed to the cement clinker prepared in steps 1 and 2 and the cement clinker mixed with the gypsum is crushed, to produce cement (step 3). In the present step, to the cement clinker or the cement mixed with gypsum, other materials such as blast furnace slug or fly ash, etc. can be mixed according to need.

### EXAMPLES

In the following, the Example of the present invention is shown, while the technical scope of the present invention is not limited to this.

Fluid simulation of the gas temperature near the burner tip part was performed for a case of using only powdered coal (powdered coal mono-combustion), for a case of adding 20% or 50% of hydrogen to powdered coal with respect to the whole thermal energy source on calorie basis, and for a case of using only hydrogen, as thermal energy source, in the calcination kiln.

These fluid simulation conditions are shown in Table 1 and the results are shown in Table 2. In this fluid simulation, the calcination kiln structure is defined as 2D axis symmetry, and the solution was obtained by applying turbulence model, radiation model, and calcination model. The present fluid simulation was performed by using a widely-used fluid simulation software, Ansys Fluent 2021, manufactured by Ansys.

TABLE 1

| | Burner powdered coal | | Burner hydrogen | | Burner primary air | | Burner secondary air | |
|---|---|---|---|---|---|---|---|---|
| | t/h | ° C. | Nm3/h | ° C. | Nm3/h | ° C. | Nm3/h | ° C. |
| Powdered coal | 11 | 30 | — | — | 12000 | 30 | 75000 | 840 |
| mono- | | | | | | | | |
| combustion | | | | | | | | |
| Hydrogen 20% | 8.8 | 30 | 5800 | 30 | 12000 | 30 | 73000 | 840 |
| mixed | | | | | | | | |
| combustion | | | | | | | | |
| Hydrogen 50% | 5.5 | 30 | 14500 | 30 | 12000 | 30 | 70000 | 840 |
| mixed | | | | | | | | |
| combustion | | | | | | | | |
| Hydrogen mono- | — | — | 29000 | 30 | 12000 | 30 | 65000 | 840 |
| combustion | | | | | | | | |

TABLE 2

| | Burner tip part |
|---|---|
| | Gas temperature (° C.) |
| Powdered coal mono-combustion | 382 |
| Hydrogen 20% mixed combustion | 422 |
| Hydrogen 50% mixed combustion | 497 |
| Hydrogen mono-combustion | 615 |

From Table 2, it can be understood that by using hydrogen as a part of thermal energy source, the temperature of the burner tip part increases. In case it is a hydrogen 20% mixed combustion, temperature increase is mild, and it is thought that there is almost no influence on the burner. On the other hand, in case the hydrogen mixed combustion ratio is 50%, the temperature near the burner tip part is increased by about 100° C. as compared to powdered coal mono-combustion, and the burner may be heat damaged depending on the heat resistant temperature of the burner. Therefore, even it depends on the burner used, it is thought that the hydrogen mixed combustion ratio is preferably 40% or less.

### INDUSTRIAL APPLICABILITY

Since the production method of cement clinker of the present invention is useful as a method and equipment for producing cement clinker. it is industrially applicable.

1. A method for producing a cement clinker comprising:
calcinating a cement clinker powder raw material injected in a calcination kiln with a kiln burner by using a thermal energy source comprising gas fuel,
wherein the used amount of the gas fuel in the thermal energy source to be used in the kiln burner is adjusted so that a temperature of the kiln burner is lower than a heat resistant temperature of the kiln burner.

2. The method for producing a cement clinker according to claim 1, wherein the temperature of the kiln burner is adjusted to be 40° C. or more below the heat resistant temperature of the kiln burner.

3. The method for producing a cement clinker according to claim 1, wherein the gas fuel is hydrogen.

4. A method for producing a cement, comprising:
mixing gypsum to the cement clinker produced by the method for producing a cement clinker according to claim 1, and
crushing the cement clinker mixed with the gypsum.

5. The method for producing a cement clinker according to claim 2, wherein the gas fuel is hydrogen. 6 (New) A method for producing a cement, comprising:
mixing gypsum to the cement clinker produced by the method for producing a cement clinker according to claim 2, and
crushing the cement clinker mixed with the gypsum.

7. A method for producing a cement, comprising:
mixing gypsum to the cement clinker produced by the method for producing a cement clinker according to claim 3, and
crushing the cement clinker mixed with the gypsum.

8. A method for producing a cement, comprising:
mixing gypsum to the cement clinker produced by the method for producing a cement clinker according to claim 5, and
crushing the cement clinker mixed with the gypsum.
